(19) United States
(12) Patent Application Publication
(10) Pub. No.: US 2003/0076391 A1
(43) Pub. Date: Apr. 24, 2003

(54) Supply adaptor for an on-axis printer

(76) Inventors: John F. Wilson, Elmwood Corvallis, OR (US); Jeffrey D. Langford, Lebanon, OR (US)

Correspondence Address: HEWLETT-PACKARD COMPANY, Intellectual Property Administration, P.O. Box 272400, Fort Collins, CO, 80527-2400, US

(21) Appl. No.: 10/053,372

(22) Filed: Oct. 24, 2001

(51) Int. Cl. B41J 2/175

(52) U.S. Cl. 347/86

(57) ABSTRACT

Embodiments of the present invention comprise apparatus and methods for modifying existing low cost “on-axis” ink jet printer systems to accommodate low intervention rate “free ink” ink supplies. Embodiments are disclosed which enable reduced intervention rates and visual ink level indication by providing a large ink container, flexible interconnect tubing, and a modified ink supply container which mounts to the printer carriage.

### TECHNICAL FIELD OF THE INVENTION

The present invention relates to an adaptor for providing ink to a printing system. More specifically, exemplary embodiments of the present invention relate to a “free ink” reservoir adaptor for an ink jet printer having on-axis ink supplies.

### BACKGROUND OF THE INVENTION

Inkjet printers typically use a printhead mounted on a carriage that is moved relative to a print media, such as paper. As the printhead is moved relative to the print media, a control system activates the printhead to deposit or eject ink droplets onto the print media to form images and text. Ink is provided to the printhead by a supply of ink that is either integral with the printhead, as in the case of a disposable print cartridge, or by a supply of ink that is replaceable separate from the printhead. With separately replaceable ink supplies, the ink supply is replaced when exhausted, and the printhead is then replaced at the end of the printhead useful life.

When the ink supply is replaceable separate from the printhead, the supply may be either located on the carriage with the printhead or located remotely from the printhead (“off axis”). Locating the supply on the carriage with the printhead is generally a less expensive approach, although the quantity of ink provided with each replaceable supply is limited by the considerations of the total mass that must be moved on the carriage, and the spatial volume swept by the carriage.

Locating the ink supplies on the carriage provides a cost effective printer configuration, as the cost of the ink delivery system is thereby reduced. Since the capacity of on-axis supplies are necessarily limited, however, the configuration may not be suitable for users having high-volume printing requirements and therefore needing a printer that will print for long periods unattended. Off axis low intervention rate printers exist, but generally at higher cost, due to the more expensive ink delivery system.

There is therefore a need for devices which allow the use of cost effective on-axis ink jet printers in a high-volume low intervention rate environment.

### SUMMARY OF THE INVENTION

Embodiments of the present invention comprise apparatus and methods for modifying existing low cost “on-axis” ink jet printer systems to accommodate low intervention rate “free ink” ink supplies. Embodiments are disclosed which enable reduced intervention rates and visual ink level indication by providing an large ink container, flexible interconnect tubing, and a modified ink supply container which mounts to the printer carriage.

Other aspects and advantages of the present invention will become apparent from the following detailed description, taken in conjunction with the accompanying drawings, illustrating by way of example the principles of the invention.

### BRIEF DESCRIPTION OF THE DRAWINGS

FIG. 1 is one exemplary embodiment of an ink jet printing system, depicted with a cover opened to show a plurality of replaceable ink containers with which the off-axis supply adaptor of the present invention may be utilized.

FIG. 2 is a simplified schematic representation of the exemplary inkjet printing system shown in FIG. 1.

FIG. 3 is a greatly enlarged perspective view of a portion of a scanning carriage showing the replaceable ink containers positioned in a receiving station that provides fluid communication between the replaceable ink containers and one or more printheads.

FIG. 4 is a side plan view of a portion of the scanning carriage showing guiding and latching features associated with each of the replaceable ink container and the receiving station for securing the replaceable ink container, thereby allowing fluid communication with the printhead.

FIG. 5 shows an exemplary embodiment of an ink jet printing system of system modified to accommodate the off-axis supply adaptor of the present invention.

FIG. 6 is a simplified exploded view illustrating an embodiment of the off-axis supply adaptor of the present invention, showing the modified ink delivery path.

FIG. 7 is a simplified schematic representation further illustrating the modified ink jet printing system of FIG. 6.

FIG. 8 is a simplified exploded view illustrating an alternate embodiment of the supply adaptor of the present invention, in which a large free-ink supply is carriage-mounted.

### DETAILED DESCRIPTION OF THE PREFERRED EMBODIMENT

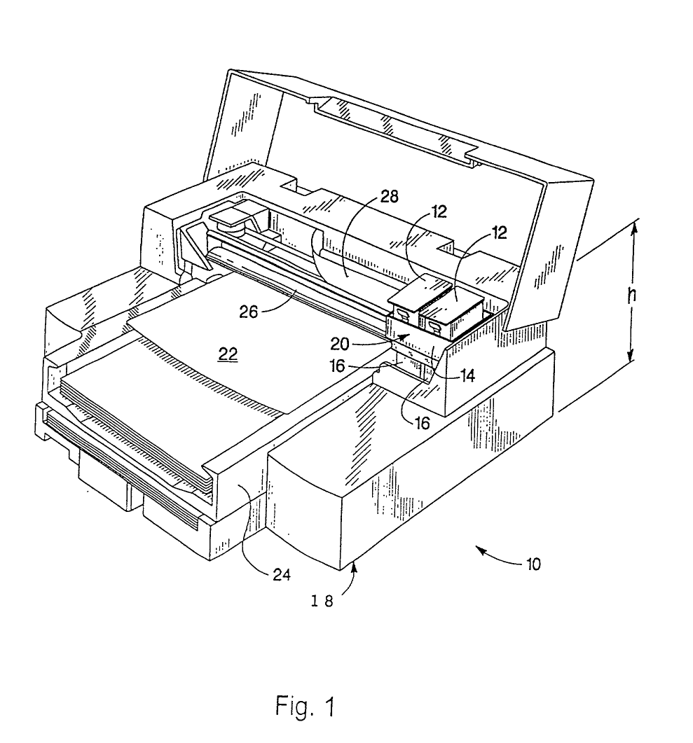

FIG. 1 is a perspective view of one exemplary embodiment of a printing system 10 shown with its cover open, that includes at least one replaceable ink container 12 installed in a receiving station 14. With the replaceable ink container 12 properly installed into the receiving portion 14, ink is provided from the replaceable ink container 12 to at least one inkjet printhead 16. The inkjet printhead 16 is responsive to activation signals from a printer portion 18 to deposit ink on print media. As ink is ejected from the printhead 16, the printhead 16 is replenished with ink from the ink container 12. In one preferred embodiment, the replaceable ink container 12, receiving station 14, and inkjet printhead 16 are each part of a scanning carriage that is moved relative to a print media 22 to accomplish printing. The printer portion 18 also includes a media tray for receiving the print media 22. As the print media 22 is stepped through a printing zone, the scanning carriage 20 moves the printhead 16 relative to the print media 22. The printer portion 18 selectively activates the printhead 16 to deposit ink on print media 22 to thereby accomplish printing.

The scanning carriage 20 is moved through the print zone on a scanning mechanism which includes a slide rod 26 on which the scanning carriage 20 slides as the scanning carriage 20 moves through a scan axis. A positioning means (not shown) is used for precisely positioning the scanning carriage 20. In addition, a paper advance mechanism (not shown) is used to step the print media 22 through the print zone as the scanning carriage 20 is moved along the scan axis. Electrical signals are provided to the scanning carriage 20 for selectively activating the printhead 16 by means of an electrical link such as a ribbon cable 28.

It is essential for the proper operation of the printing system that, when an ink container 12 is replaced, both proper fluidic and electrical connection be established between the ink container 12 and the printer portion 18. The fluidic interconnection allows a supply of ink within the replaceable ink container 12 to be fluidically coupled to the printhead 16 for providing a source of ink to the printhead 16. The electrical interconnection allows information to be passed between the replaceable ink container 12 and the printer portion 18. Information passed between the replaceable ink container 12 and the printer portion 18 can include, by way of example, information related to the compatibility of replaceable ink container 12 with printer portion 18 and operation status information such as the ink level information.

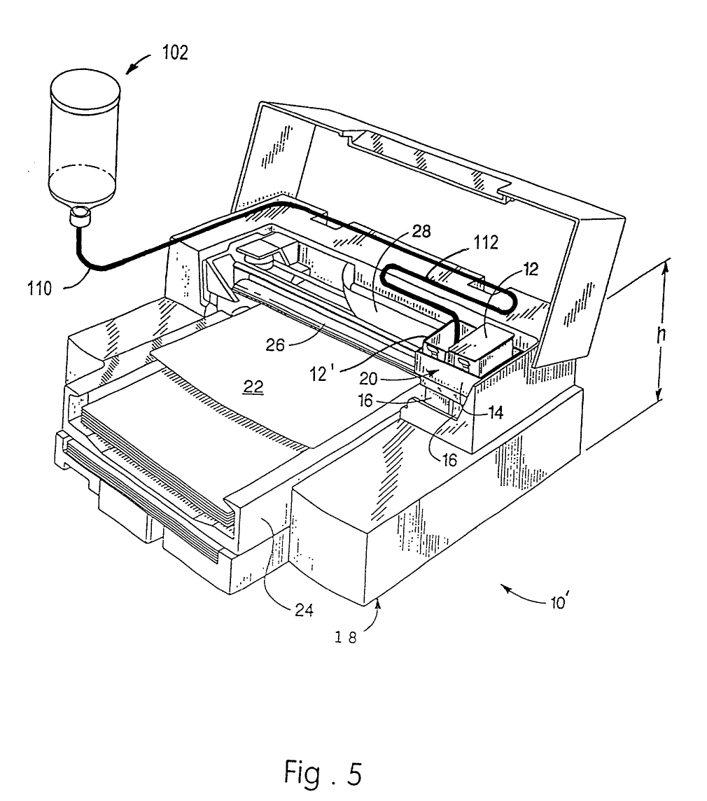

New ink containers 12 are provided to the printer user with the fluid port sealed to prevent ink spillage during shipping and storage. It is critical that the fluid port be unsealed prior to installing a new ink container in the printer, since operating the printer without a reliable supply of ink can cause permanent damage of the printheads. The fluid interconnect label lock-out tab of the present invention, as will be discussed with respect to FIGS. 5 through 10, ensures that a new ink container 12 is not installed into the receiving portion 14 with the fluid interconnect seal in place.

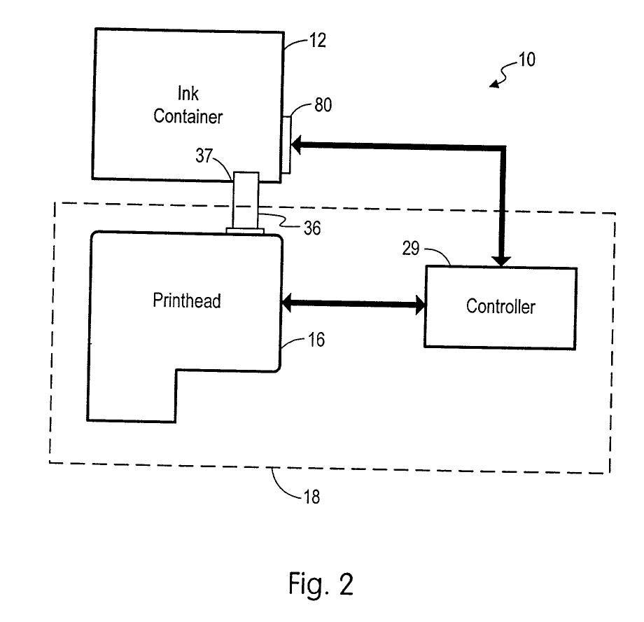

FIG. 2 is a simplified schematic representation of the exemplary inkjet printing system 10 shown in FIG. 1. FIG. 2 is simplified to illustrate a single printhead 16 connected to a single ink container 12. The inkjet printing system 10 of the present invention includes the printer portion 18 and the ink container 12, which is configured to be received by the printer portion 18. The printer portion 18 includes the inkjet printhead 16 and a controller 29. With the ink container 12 properly inserted into the printer portion 18, an electrical and fluidic coupling is established between the ink container 12 and the printer portion 18. The fluidic coupling allows ink stored within the ink container 12 to be provided to the printhead 16. Upon installation of the ink container, a fluid interconnect 36 engages the fluid port 37 of the ink container, establishing fluid flow. The fluid interconnect 36 may comprise a separate manifold component on the scanning carriage 20, as discussed below. The electrical coupling allows information to be passed between an electrical storage device 80 disposed on the ink container 12 and the printer portion 18. The exchange of information between the ink container 12 and the printer portion 18 is to ensure the operation of the printer portion 18 is compatible with the ink contained within the replaceable ink container 12 thereby achieving high print quality and reliable operation of the printing system 10.

The controller 29, among other functions, controls the transfer of information between the printer portion 18 and the replaceable ink container 12. In addition, the controller 29 controls the transfer of information between the printhead 16 and the controller 29 for activating the printhead to selectively deposit ink on print media, and controls the relative movement of the printhead 16 and print media. The controller 29 performs additional functions such as controlling the transfer of information between the printing system 10 and a host device such as a computer (not shown).

In order to ensure the printing system 10 provides high quality images on print media, the controller 29 may utilize parameters that are provided by the electrical storage device 80 to optimize the printer operation. Among the parameters, for example, that can be stored in the electrical storage device 80 associated with the replaceable ink container 12 are following: a date code associated with the replaceable ink container 12, a date code of initial insertion of the ink container 12, system coefficients, ink type and ink color, ink container size, printer model number or identification number and container usage information, just to name a few.

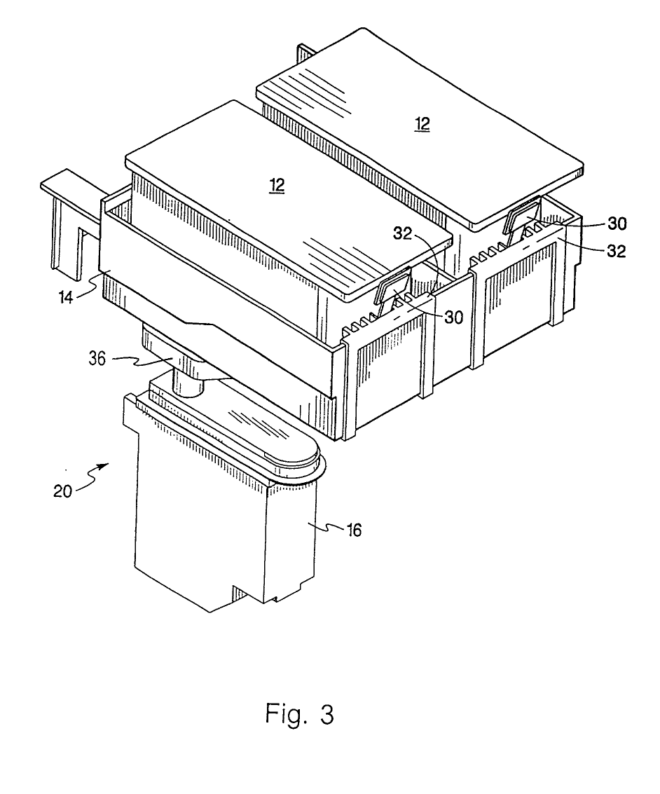

FIG. 3 is a perspective view of a portion of the scanning carriage 20 showing a pair of replaceable ink containers 12 properly installed in the receiving station 14. An inkjet printhead 16 is in fluid communication with the receiving station 14. In the preferred embodiment, the inkjet printing system 10 shown in FIG. 1 includes a tri-color ink container containing three separate ink colors (cyan, magenta, and yellow) and a second ink container containing black ink. The replaceable ink containers 12 can be partitioned differently to contain fewer than three ink colors or more than three ink colors if more are required. For example, in the case of high fidelity printing, frequently six or more colors are used.

The scanning carriage portion 20 shown in FIG. 3 is shown fluidically coupled to a single printhead 16 for simplicity. In the exemplary embodiment, four inkjet printheads 16 are each fluidically coupled to the receiving station 14. In this embodiment, each of the four printheads are fluidically coupled to each of the four colored inks contained in the replaceable ink containers 12.

Each of the replaceable ink containers 12 include a latch 30 for securing the replaceable ink container 12 to the receiving station 14. The receiving station 14 in the preferred embodiment includes a set of keys 32 that interact with corresponding keying features (not shown) on the replaceable ink container 12. The keying features on the replaceable ink container 12 interact with the keys 32 on the receiving station 14 to ensure that the replaceable ink container 12 is compatible with the receiving station 14.

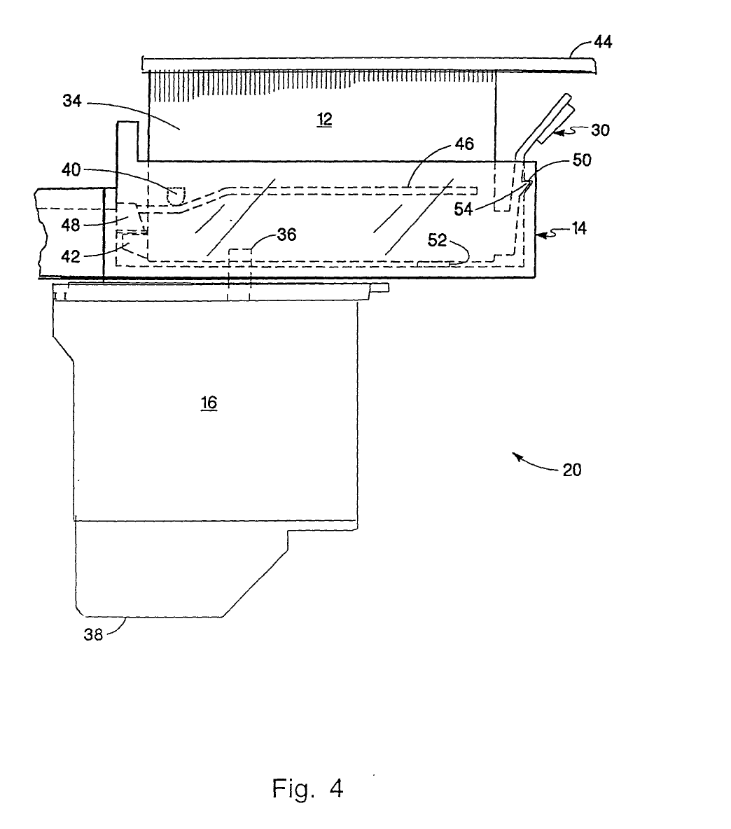

FIG. 4 is a side plan view of the scanning carriage portion 20 shown in FIG. 2. The scanning carriage portion 20 includes the ink container 12 shown properly installed into the receiving station 14, thereby establishing fluid communication between the replaceable ink container 12 and the printhead 16. The replaceable ink container 12 includes a reservoir portion 34 for containing one or more quantities of ink. In the exemplary embodiment, the tri-color replaceable ink container 12 has three separate ink containment reservoirs, each containing ink of a different color. The black replaceable ink container 12 is a single ink reservoir 34 for containing black ink. In the exemplary embodiment, the reservoir 34 has a capillary storage member (not shown) disposed therein. The capillary storage member is a porous member having sufficient capillarity to retain ink to prevent ink leakage from the reservoir 34 during insertion and removal of the ink container 12 from the printing system 10.

This capillary force must be sufficiently great to prevent ink leakage from the ink reservoir 34 over a wide variety of environmental conditions such as temperature and pressure changes. In addition, the capillarity of the capillary member is sufficient to retain ink within the ink reservoir 34 for all orientations of the ink reservoir as well as a reasonable amount of shock and vibration the ink container may experience during normal handling. The preferred capillary storage member is a network of heat bonded polymer fibers, although any suitable capillary material may be used.

Once the ink container 12 is properly installed into the receiving station 14, the ink container 12 is fluidically coupled to the printhead 16 by way of fluid interconnect 36. Upon activation of the printhead 16, ink is ejected from the ejection portion 38 producing a negative gauge pressure, sometimes referred to as backpressure, within the printhead 16. This negative gauge pressure within the printhead 16 is sufficient to overcome the capillary force resulting from the capillary member disposed within the ink reservoir 34. Ink is drawn by this backpressure from the replaceable ink container 12 to the printhead 16. In this manner, the printhead 16 is replenished with ink provided by the replaceable ink container 12.

The fluid interconnect 36 of the exemplary embodiment is preferably an upstanding ink pipe that extends upwardly into the ink container 12 and downwardly to the inkjet printhead 16. The fluid interconnect 36 is shown greatly simplified in FIG. 4. In the exemplary embodiment, the fluid interconnect 36 is a manifold that allows for offset in the positioning of the printheads 16 along the scan axis, thereby allowing the printhead 16 to be placed offset from the corresponding replaceable ink container 12. In the preferred embodiment, the fluid interconnect 36 extends into the reservoir 34 to compress the capillary member, thereby forming a region of increased capillarity adjacent the fluid interconnect 36. This region of increased capillarity tends to draw ink toward the fluid interconnect 36, thereby allowing ink to flow through the fluid interconnect 36 to the printhead 16.

The replaceable ink container 12 further includes a guide feature 40, an engagement feature 42, a handle 44 and a latch feature 30 that allow the ink container 12 to be inserted into the receiving station 14 to achieve reliable fluid interconnection with the printhead 16 as well as form reliable electrical interconnection between the replaceable ink container 12 and the scanning carriage 20.

The receiving station 14 includes a guide rail 46, an engagement feature 48 and a latch engagement feature 50. The guide rail 46 cooperates with the guide rail engagement feature 40 and the replaceable ink container 12 to guide the ink container 12 into the receiving station 14. Once the replaceable ink container 12 is fully inserted into the receiving station 14, the engagement feature 42 associated with the replaceable ink container engages the engagement feature 48 associated with the receiving station 14, securing a front end or a leading end of the replaceable ink container 12 to the receiving station 14. The ink container 12 is then pressed downward to compress a spring biasing member 52 associated with the receiving station 14 until a latch engagement feature 50 associated with the receiving station 14 engages a hook feature 54 associated with the latch member 30 to secure a back end or trailing end of the ink container 12 to the receiving station 14. It is the cooperation of the features on the ink container 12 with the features associated with the receiving station 14 that allow proper insertion and functional interfacing between the replaceable ink container 12 and the receiving station 14.

FIG. 5 depicts an exemplary embodiment of an ink jet printing system 10′ modified to accommodate the off-axis supply adaptor of the present invention. As shown in FIG. 5, an off-axis Ink supply 102 is plumbed via a flexible tube 110 to the fluidic interconnect between the scanning print head and the original on axis ink supply. A relief loop 112 in the tube allows the printer scanning carriage portion 20 to freely scan across the media 22. The remote supply 102 may be attached to the side of the printer housing at the appropriate height relative to the print head to provide appropriate system backpressure and fluid flow function, or may be otherwise mounted in any convenient manner. Furthermore, the supply pressure may be controlled in some other manner to allow convenient mounting of the remote supply, such as by pressurizing the supply, as is well-known in the art (not shown). The supply 102 is preferably made of a clear material to provide visual ink level feedback to the operator, or the supply could incorporate any of a number of common fluid level indicators known in the art. The flexible tube 110 (excepting the relief loop) may be affixed to the printer in any convenient manner, such as adhesives or plastic ties.

For printing systems that require electronic communication between the printer and the electrical storage device 80 (not shown in FIG. 5) on the on-axis ink supply, either an old (modified) ink supply 12′, as discussed below, or an electronic device emulating the function of an electrical storage device can be used to preserve the required electrical interface. While FIG. 5 illustrates a printer system modified to accept an off-axis supply of one ink color, such as black; the concept of the present invention may be extended to multiple off-axis supplies.

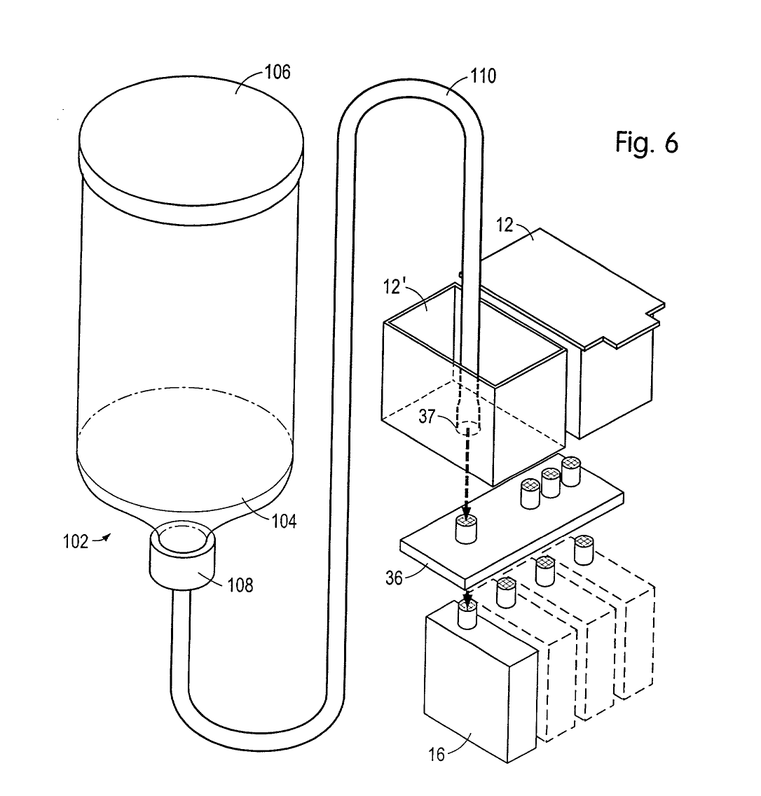

FIG. 6 is a simplified exploded view of the off-axis supply adaptor of the present invention, showing the modified ink delivery path. The off-axis ink supply 102 of the exemplary embodiment comprises a clear plastic container 104 with a removable top lid 106 to allow for easy refilling, and is connected to the flexible tube 110 by a cap 108.

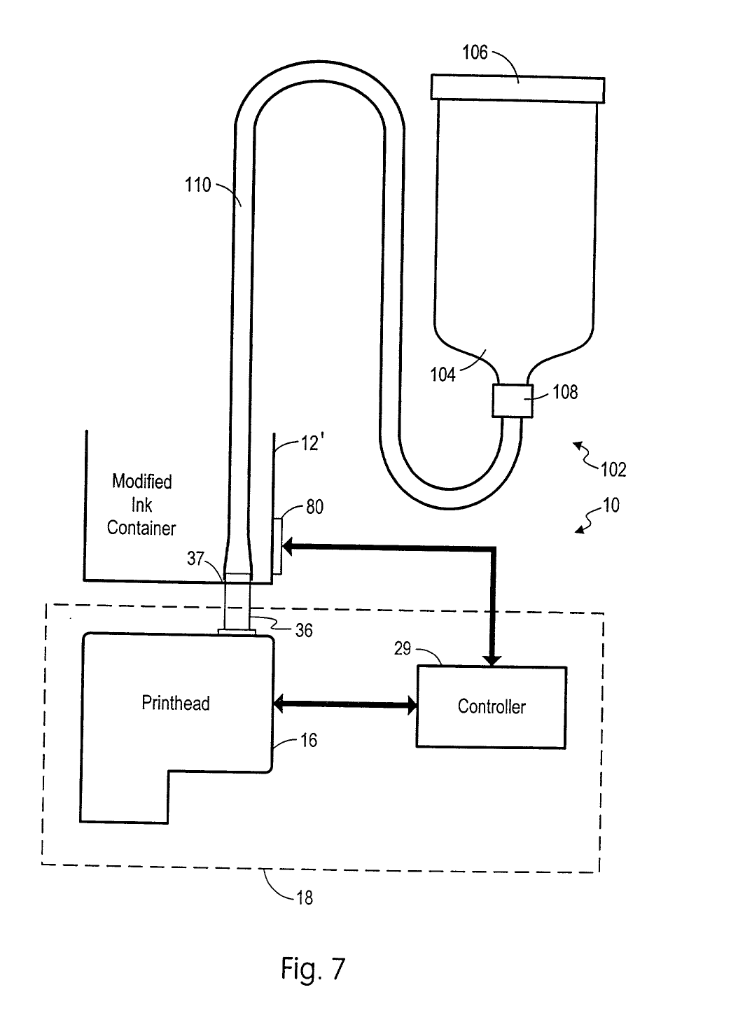

As shown in FIG. 6, modified ink supply 12′ comprises a standard ink supply with both the top cover and the internal capillary material removed, thus providing access to the fluid port 37 of the ink container. The electrical storage device 80 (not shown in FIG. 6) of the modified ink supply is discussed with respect to FIG. 7, below. In the exemplary embodiment, the flexible tube 110 engages the fluid interconnect 36 of the printer, which extends through the fluid port 37 when the modified ink supply is installed in the printer. The off-axis ink supply 102 is thus in fluid communication with printhead 16. In the exemplary embodiment, the flexible tube is first “primed” with ink prior to attachment to the fluid interconnect 36 to avoid ink starvation of the printhead.

FIG. 7 is a simplified schematic representation further illustrating the modified ink jet printing system 10 of FIG. 6, with a single printhead 16 connected to a single ink container 12. The printer portion 18 includes the inkjet printhead 16 and a controller 29. Modified ink container 12′ provides electrical and fluidic coupling with the printer portion 18 as discussed with respect to FIG. 2, above. The electrical coupling allows information to be passed between the electrical storage device 80 on the modified ink container 12′ and the printer portion 18. The exchange of information between the modified ink container 12′ and the printer portion 18 provides compatibility with the printer by implementing or emulating those functions discussed with respect to the unmodified printer system of FIG. 2, above. The electrical storage device may also be programmed to optimize printing with the off-axis adaptor, with data indicating any special characteristics of the off-axis supply, such as the ink capacity of the supply.

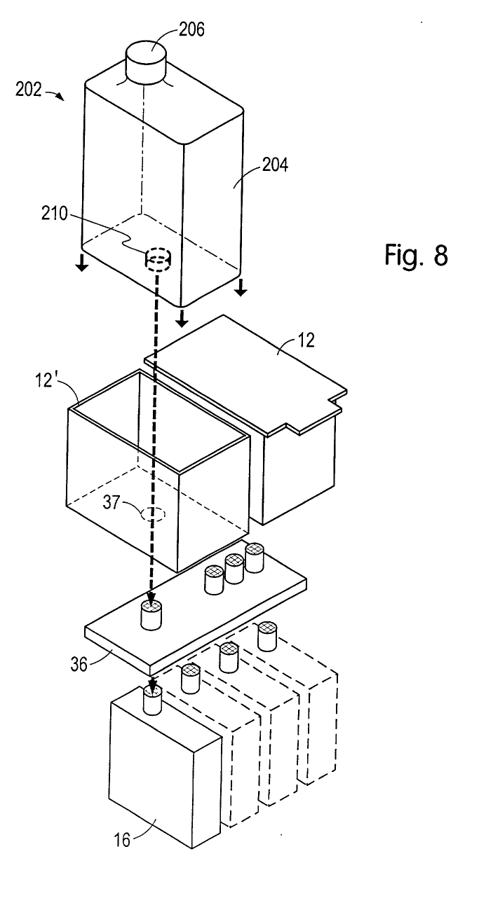

FIG. 8 is a simplified exploded view illustrating an alternate embodiment of the supply adaptor of the present invention, in which a large free-ink supply is carriage-mounted. The carriage-mounted ink supply 202 of the alternate embodiment comprises a clear plastic container 204 with a removable top lid 206 to allow for easy refilling. A short resilient member 210, which may be a piece of flexible tubing, allows the supply to engage the fluid interconnect 36 of the printer which extends through the fluid port 37 when the modified ink supply is installed in the printer. As in the above-described exemplary embodiment, the modified ink supply 12′ comprises a standard ink supply with both the top cover and the internal capillary material removed. In use, the carriage-mounted supply is installed in the printer and then filled with ink. The operator can visually monitor the ink level in the supply, and refill it when necessary.

While described above with respect to a single off-axis ink supply, the present invention may be extended to multiple off-axis supplies, such as supplies for each primary color in a color printing system. In a color printing system, the present invention provides the additional benefit of lower ink wastage, since printer users who tend to predominantly print specific colors can replenished the colors separately, as opposed to the replacing a common “ganged” on-axis color ink supply.

The modified printing system of the present invention provides an option to printer users who want to purchase a lower price on-axis ink supply printer and maintain the flexibility to use it in high usage applications with a convenient intervention rate and lower overall cost per page operating costs. This present invention also provides visual feedback to the user about ink level therefore protecting against premature print head degradation (from air ingestion).

Although described with respect to a particular exemplary embodiment, the present invention is applicable to other printer systems having on-axis ink supplies separately replaceable from the printheads.

The above is a detailed description of particular embodiments of the invention. It is recognized that departures from the disclosed embodiments may be within the scope of this invention and that obvious modifications will occur to a person skilled in the art. It is the intent of the applicant that the invention include alternative implementations known in the art that perform the same functions as those disclosed. This specification should not be construed to unduly narrow the full scope of protection to which the invention is entitled.

What is claimed is:

1. An ink delivery system for providing ink to the scanning carriage of an ink jet printer, the printer configured to receive carriage-mounted ink supplies separately replaceable from the printheads, comprising:
an ink container;
an adaptor member configured to be received by a printer carriage in place of a carriage mounted ink supply; and
flexible tubing fluidically coupling the ink container with the adaptor member.

2. The ink delivery system for providing ink to the scanning carriage of an ink jet printer of claim 1, wherein the ink container further comprises an ink level indicator.

3. The ink delivery system for providing ink to the scanning carriage of an ink jet printer of claim 2, wherein the ink container has an outer wall and an inner ink-containing chamber, and wherein the ink level indicator comprises a substantially clear portion of the outer wall permitting visual inspection of ink within the ink containing chamber.

4. The ink delivery system for providing ink to the scanning carriage of an ink jet printer of claim 1, wherein the ink container further comprises a top lid, the top lid replaceably removable for replenishing ink within the ink container.

5. The ink delivery system for providing ink to the scanning carriage of an ink jet printer of claim 1, wherein the ink container further comprises a lower cap, the lower cap retaining the flexible tubing to the in container.

6. The ink delivery system for providing ink to the scanning carriage of an ink jet printer of claim 1, wherein the ink container further comprises an ink level indicator.

7. The ink delivery system for providing ink to the scanning carriage of an ink jet printer of claim 1, wherein the adaptor member has a fluid port configured to duplicate the fluid port on a carriage-mounted ink container, and wherein the flexible tubing connects to the fluid port.

8. The ink delivery system for providing ink to the scanning carriage of an ink jet printer of claim 1, wherein the adaptor member further comprises an electrical storage device and electrical contacts configured to duplicate the electrical contacts on a carriage-mounted ink container.

9. The ink delivery system for providing ink to the scanning carriage of an ink jet printer of claim 8, wherein the electrical storage device is preprogrammed with information to emulate the information in a carriage-mounted ink container electrical storage device.

10. The ink delivery system for providing ink to the scanning carriage of an ink jet printer of claim 1, wherein the flexible tubing forms a relief loop allowing normal scanning of the printer carriage.

11. An ink delivery system for providing ink to the scanning carriage of an ink jet printer, the printer configured to receive carriage-mounted ink supplies separately replaceable from the printheads, comprising:
ink container means;
adaptor means configured to be received by a printer carriage in place of a carriage mounted ink supply; and
tubing means fluidically coupling the ink container means with the adaptor means.

12. An ink delivery system for providing ink to the scanning carriage of an ink jet printer, the printer configured to receive carriage-mounted ink supplies separately replaceable from the printheads, comprising:
an ink container formed from a plastic bottle;
an adaptor member formed from a standard carriage-mountable ink supply and configured to be received by a printer carriage in place of a carriage mounted ink supply; and
flexible tubing fluidically coupling the ink container with the adaptor member.

13. The ink delivery system for providing ink to the scanning carriage of an ink jet printer of claim 12, wherein the ink container further comprises an ink level indicator.

14. The ink delivery system for providing ink to the scanning carriage of an ink jet printer of claim 13, wherein the ink container has an outer wall and an inner ink-containing chamber, and wherein the ink level indicator comprises a substantially clear portion of the outer wall permitting visual inspection of ink within the ink containing chamber.

15. The ink delivery system for providing ink to the scanning carriage of an ink jet printer of claim 12, wherein the ink container further comprises a top lid, the top lid replaceably removable for replenishing ink within the ink container.

16. The ink delivery system for providing ink to the scanning carriage of an ink jet printer of claim 12, wherein the ink container further comprises a lower cap, the lower cap retaining the flexible tubing to the in container.

17. The ink delivery system for providing ink to the scanning carriage of an ink jet printer of claim 12, wherein the ink container further comprises an ink level indicator.

18. The ink delivery system for providing ink to the scanning carriage of an ink jet printer of claim 12, wherein the carriage-mountable ink supply from which the adaptor is formed has an outer wall and internal capillary material, and the adaptor is formed by removing a portion of the outer wall and discarding the capillary material.

19. The ink delivery system for providing ink to the scanning carriage of an ink jet printer of claim 12, wherein the adaptor member further comprises an electrical storage device and electrical contacts configured to duplicate the electrical contacts on a carriage-mounted ink container.

20. The ink delivery system for providing in to the scanning carriage of an ink jet printer of claim 19, wherein the electrical storage device is preprogrammed with information to emulate the information in a carriage-mounted ink container electrical storage device.

21. The ink delivery system for providing ink to the scanning carriage of an ink jet printer of claim 12, wherein the flexible tubing forms a relief loop allowing normal scanning of the printer carriage.

22. An ink delivery system for providing ink to the scanning carriage of an ink jet printer, the printer configured to receive carriage-mounted ink supplies separately replaceable from the printheads, comprising:
an adaptor member configured to be received by a printer carriage in place of a carriage mounted ink supply, the adaptor member having an open top portion for receiving an ink container;
an ink container for containing free ink; and
a resilient member fluidically coupling the ink container with the adaptor member.

23. The ink delivery system for providing ink to the scanning carriage of an ink jet printer of claim 22, wherein the ink container further comprises a removable cap for replenishing the ink supply.

24. The ink delivery system of claim 22 wherein the ink container comprises an ink level indicator.

25. A method of providing ink to the scanning carriage of an ink jet printer, the printer configured to receive carriage-mounted ink supplies separately replaceable from the printheads, comprising:
providing an external supply of ink;
affixing an adaptor member to the printer carriage, the adaptor member configured to be received by a printer carriage in place of a carriage mounted ink supply; and
fluidically coupling the ink supply to the adaptor member.
